(19) United States
(12) Patent Application Publication
(10) Pub. No.: US 2022/0261538 A1
(43) Pub. Date: Aug. 18, 2022

(54) SKIPPING NATURAL LANGUAGE PROCESSOR

(71) Applicant: Inteliquet, Inc., Wilmington, DE (US)

(72) Inventors: Brian Berns, Bethesda, MD (US); Kirk Junker, Hillsboro, VA (US)

(73) Assignee: Inteliquet, Inc., Wilmington, DE (US)

(21) Appl. No.: 17/177,834

(22) Filed: Feb. 17, 2021

(51) Int. Cl. G06F 40/205

(52) U.S. Cl. CPC G06F 40/205

(57) ABSTRACT

A skipping natural language parser can include: identifying a candidate location within a string of characters with a processor, the candidate location being an unbroken string of relevant characters followed by an irrelevant character; attempting to parse an attribute from the candidate location with the processor; storing the attribute in a memory based on the attribute being parsed; skipping to a next candidate location based on the attribute being parsed with the processor; and skipping, the relevant characters of the candidate location and the irrelevant character following the candidate location, to the next candidate location based on the attribute not being parsed with the processor.

### TECHNICAL FIELD

This disclosure relates to Natural Language Processing (NLP), more particularly to NLP systems implementing parser combinators.

### BACKGROUND

Modern companies, organizations, and entire industries have come to rely heavily on digital data management. Data management has become a critically important aspect of successfully operating in many fields including government, engineering, and health.

The medical field, for example, provides a helpful illustration of one industry, among many, that is moving quickly to rely on automatically digitized records for properly and timely diagnosing, treating, and billing medical patients. Notes relying on non-standard or technical syntax and vocabulary arise in many other industries, and for ease of description, the medical industry will be relied on as one, non-limiting, illustrative example.

Notably, the medical field generates massive amounts of written notes and documents, including pathology reports and prescriptions, for example, that include and rely on dense medical jargon and thereby prevents automatic parsing and extraction by today's best automatic language processors.

Illustratively for example, drug instructions are short notes of natural language text that describes how to take a medication. While drug instructions may be described in accordance with industry accepted grammar, syntax, and abbreviations, these drug instructions rarely resemble common speech and instead often rely on non-standard or technical syntax and vocabulary.

As such, drug instructions can be very difficult for a computer program to parse and extract relevant information. As industrial data management technology advances and industry comes to rely all the more on automated tools, the need to automatically parse and extract information grows daily.

Currently humans are not capable of parsing and extracting the vast numbers of documents. Furthermore, when human operators do digitize non-standard or technical syntax and vocabulary, they rely on previous experience in using terms, subjective judgments, and doctor confirmations, which are not reproducible by computer or efficiently practiced by people when operating at high volumes.

Thus, the need to automatically parse and extract information from notes using non-standard or technical syntax and vocabulary has become an obvious and pressing need. Automatically parsing and extracting information from notes using non-standard or technical syntax and vocabulary, such as dense medical jargon, has therefore been identified as an important area for development of next generation technology.

Technical solutions are actively being sought that can automatically extract very specific information from a large volume of such notes, regardless of their structure or purpose. Previous technical solutions fall short for many reasons and currently there is no suitable solution for automatically parsing and extracting information from notes using non-standard or technical syntax and vocabulary.

This long standing need is felt all the more as written notes and documents are digitized together with voice transcripts at an ever accelerating rate. Any technical solution will require the parsing of text that is not grammatically correct, written in short-hand, or written with many technical terms of art.

These texts, for example, are often found in medical notes written by doctors. Previous solutions fail to provide a parsing solution for text that is not grammatically correct, written in short-hand, or written with many technical terms of art.

Illustratively, conventional natural language processing (NLP) techniques are usually ineffective for drug instructions because such notes are typically very terse and written in dense medical jargon. Furthermore, drug instructions often do not follow a well-defined format or obey rules of grammar.

For example, a drug instruction might be written as: “Take one tablet PO Q6 hours prn nausea”. In this example, the term “PO” is commonly used to signify taking a drug by mouth. Furthermore, drug instructions typically do not name the medication.

As will be appreciated, however, the NLP technology only operates effectively on data having correct grammar with standard vocabulary. This technical limitation prevents drug instructions from being parsed.

In reliance on the previous example, an NLP would err at the use of acronyms, partial words, terms of art, and symbols such as “PO”, “Q6”, and “prn”. Furthermore, no NLP is known to extract specific parameters, from notes utilizing these acronyms. That is, not only does NLP fail to provide a technical solution for extracting parameters within notes but is also technically limited in its ability to parse notes having technical grammar and vocabulary used in technical ways that are not common in speech.

Traditional NLPs also produce outputs like syntax trees and named entities rather than the very specific healthcare data elements that can be contained therein, and required for medical diagnosis, treatment, or billing, for example. NLPs therefore fail to provide a complete solution for automatically parsing notes having technical grammar and non-standard vocabulary.

Other technological solutions are used when text or notes use a formal structure. When text or notes follow a formal pre-defined information and grammatical structure, parser combinators can be used. Parser combinators are small pieces of software code that parse particular types of text.

However, parser combinators currently require a structured text that follows a specific rigid grammar, this results from parser combinators getting derailed by syntax that the parser combinator does not understand or that might be irrelevant. When a parser combinator reaches and attempts to parse non-standard text the parser combinator will return an error for the entire text.

Furthermore, errors generated by parser combinators fail to identify the position of the error within the text preventing correction or assessment. Current parser combinators therefore fail to provide a solution for notes and text using non-standard or technical syntax and vocabulary. In reliance on the previous drug instruction example, the traditional parser combinators would err at the use of acronyms, partial words, terms of art, and symbols such as “PO”, “Q6”, and “pm”.

Other solutions such as statistical NLP, or machine learning, have also been developed. Statistical NLPs, including machine learning systems, however, require large data sets to train the system, and without which, the system will fail to provide useful results. Large datasets can be difficult and expensive to construct and, in some cases, enough data simply does not exist to train a statistical system.

Particularly, data used for statistical NLP requires both the data and the outcome associated with the data to be defined in order to train the system. The need for large volumes of data combined with the need to have this data adequately and accurately described means that many industries simply do not have the data required to train a statistical NLP.

Large datasets are not merely a problem related to logistics or data access but are a result of a technical reliance on guess and check. That is, the statistical NLP technology is trained by guessing and checking a voluminous amount of training documents. Illustratively, a statistical NLP may require hundreds of training documents for each medical diagnosis and prescription. When there are thousands of possible instructions, the training data requirements become an astronomical technical problem designed into the technology of the statistical NLP itself.

Solutions have been long sought but prior developments have not taught or suggested any complete solutions, and solutions to these problems have long eluded those skilled in the art. Thus, there remains a considerable need for technical solutions that can automatically parse notes having non-standard or technical syntax and vocabulary.

### SUMMARY

A skipping natural language parser, providing successful parsing of character strings having non-standard or technical syntax and vocabulary and without requiring massive computational resources of statistical systems, are disclosed. The natural language parser can include: identifying a candidate location within a string of characters with a processor, the candidate location being an unbroken string of relevant characters followed by an irrelevant character; attempting to parse an attribute from the candidate location with the processor; storing the attribute in a memory based on the attribute being parsed; skipping to a next candidate location based on the attribute being parsed with the processor; and skipping, the relevant characters of the candidate location and the irrelevant character following the candidate location, to the next candidate location based on the attribute not being parsed with the processor.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The natural language parser is illustrated in the figures of the accompanying drawings which are meant to be exemplary and not limiting, in which like reference numerals are intended to refer to like components, and in which:

FIG. 1 is a block diagram of the natural language parser.

FIG. 2 is a control flow overview of the natural language parser of FIG. 1.

FIG. 3 is the parse attribute step of FIG. 2 and the modify attribute step of FIG. 2 in a first embodiment.

FIG. 4 is the frequency attribute parser combinator of FIG. 3.

FIG. 5 is the numeric frequency parser combinator of FIG. 4.

FIG. 6 is the strength attribute parser combinator of FIG. 3.

FIG. 7 is the parse false match step of FIG. 2.

FIG. 8 is the parse attribute step of FIG. 2 in a second embodiment.

### DETAILED DESCRIPTION

In the following description, reference is made to the accompanying drawings that form a part hereof, and in which are shown by way of illustration, embodiments in which the natural language parser may be practiced. It is to be understood that other embodiments may be utilized and structural changes may be made without departing from the scope of the natural language parser.

When features, aspects, or embodiments of the natural language parser are described in terms of steps of a process, an operation, a control flow, or a flow chart, it is to be understood that the steps can be combined, performed in a different order, deleted, or include additional steps without departing from the natural language parser as described herein.

The natural language parser is described in sufficient detail to enable those skilled in the art to make and use the natural language parser and provide numerous specific details to give a thorough understanding of the natural language parser; however, it will be apparent that the natural language parser may be practiced without these specific details. In order to avoid obscuring the natural language parser, some well-known system configurations and descriptions are not disclosed in detail.

For the purposes of this application, “parser combinator” is defined as a combinatory recursive descent parsing technology. Parser combinators combine basic parsers to construct parsers enabling more complex rules to be applied during a parsing operation.

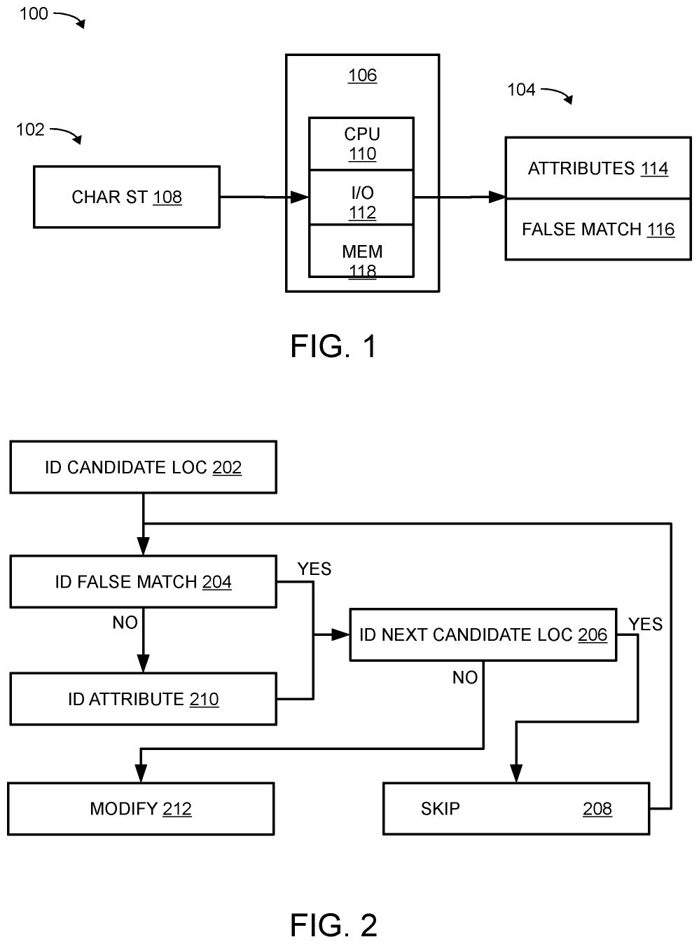

Referring now to FIG. 1, therein is shown a block diagram of the natural language parser 100. The natural language parser 100 can include an input 102 and an output 104, the output 104 provided by way of computational resources 106.

The input 102 can be a character string 108. The character string 108 is contemplated to be a string of characters in a standard electronic character encoding such as ASCII, Unicode, ISO-8859, or other character encoding standard.

It is further contemplated that the input 102 may be in the form of speech or printed language. When the input 102 is in the form of speech or printed language, an intermediate interpretation step including commonly available speech recognition or optical character recognition can be used to convert speech or printed language to a standard electronic character encoding for use with the natural language parser 100.

The character string 108 can be in any form and is not required to conform to any particular structure, grammatical rules, or syntactic rigor. This represents a major improvement over conventional natural language parsers utilizing parser combinators, which do require that any input have a particular structure, follow grammatical rules, and observe syntactic rigor in order for successful parsing.

The computational resources 106 can include a processor, such as a central processing unit 110 in useful association with instructions for executing steps, such as those of FIG. 2 below, for the natural language parser 100. The central processing unit 110 can be a single processing element or can comprise multiple or distributed elements. The central processing unit 110 can also process and parse the character string 108 based on the steps, functions, and processes described herein.

The computational resources 106 of the classification code parser 100 can further include input/output elements 112 for receiving the character string 108. The input/output elements 112 can include digital transceivers for transmitting and receiving data from peripherals and between components of the computational resources 106. The input/output elements 112 can also include visual or audio displays and visual, audio, and textual inputs such as cameras, microphones, and keyboards.

The output 104 generated by the central processing unit 110 can include attributes 114 and false matches 116. The attributes 114 and the false matches 116 can be transmitted with the input/output elements 112 and stored within memory 118. The memory 118 can be volatile, semi-volatile, or non-volatile computer readable medium and can be a non-transitory computer readable medium.

Referring now to FIG. 2, therein is shown a control flow overview of the natural language parser 100 of FIG. 1. The natural language parser 100 can begin by identifying a candidate location within the character string 108 of FIG. 1.

More particularly, the natural language parser 100 can execute an identify candidate location step 202 with the central processing unit 110 of FIG. 1. The candidate location is an unbroken string of relevant characters followed by zero or more irrelevant characters.

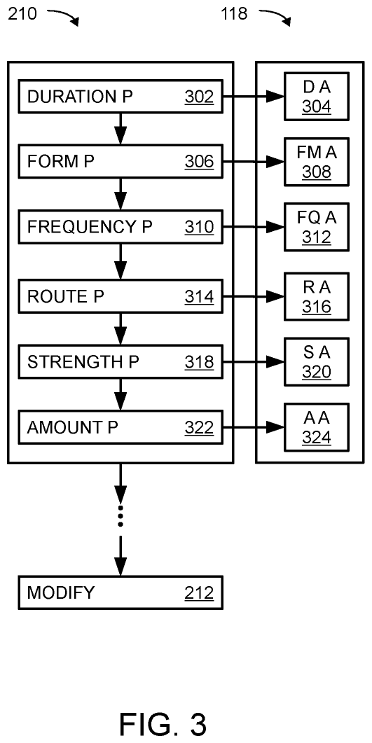

The relevant characters and irrelevant characters can be predefined and hard coded for a particular application of the natural language parser 100 such as the drug instruction parser described in FIG. 3 below. Illustratively, for the drug instruction parser, the relevant characters can be defined as letters, digits, the period symbol “.”, and the division symbol “/”.

Continuing with the drug instruction parser example, the irrelevant characters can be defined as any character other than letters, digits, the period symbol “.”, and the division symbol “/”. It will be appreciated that other applications of the natural language parser 100 might predefine the relevant characters and the irrelevant characters differently without deviating from the natural language parser 100 as herein described.

The candidate location can be an unbroken string of one or more relevant characters. The relevant characters can be followed by zero irrelevant characters, such as when the candidate location is at the end of the character string 108. Furthermore, the candidate location can be followed by one or more irrelevant characters when the candidate location is within the character string 108.

Once the candidate location is identified in the identify candidate location step 202, the natural language parser 100 can execute a parse false match step 204. The parse false match step 204 can parse and identify the false matches 116 of FIG. 1.

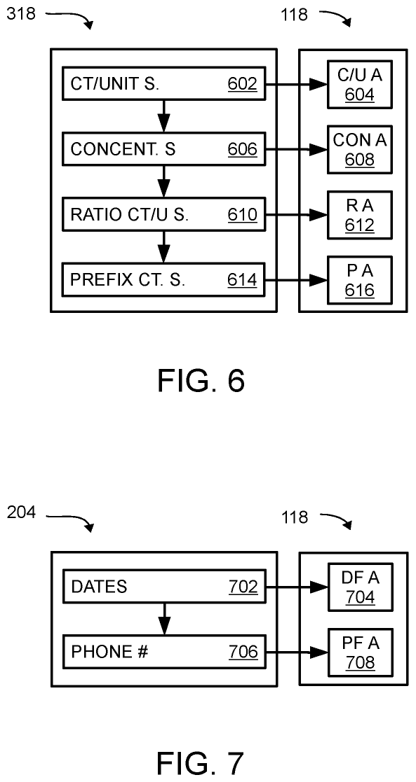

The parse false match step 204 can parse the false matches 116 by identifying a predefined format or pattern of relevant characters as described below in FIG. 7, for example. If the false match 116 is detected, the natural language parser 100 can store the false match 116 within the memory 118 of FIG. 1 and execute an identify next candidate location step 206.

Similar to the identify candidate location step 202, the identify next candidate location step 206 can identify a subsequent or next candidate location which is an unbroken string of relevant characters followed by zero or more irrelevant characters. If the identify next candidate location step 206 is able to identify a next candidate location, the natural language parser 100 can execute a skip step 208.

The skip step 208 will skip the relevant characters within the original candidate location and the irrelevant characters between the original candidate location and the next candidate location within the character string 108. Once the skip step 208 has been completed the natural language parser 100 will again execute the parse false match step 204.

If the parse false match step 204 fails to detect the false match 116 within the candidate location, the natural language parser 100 will execute a parse attribute step 210 on the same candidate location as the parse false match step 204. Furthermore, if the parse false match step 204 is operating on the next candidate location, the parse attribute step 210 will operate on the same next candidate location as the parse false match step 204.

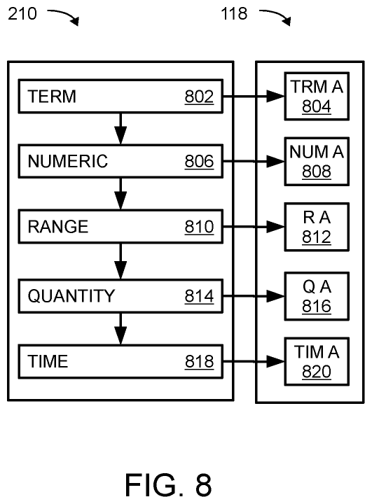

The parse attribute step 210 can employ parser combinators to identify and parse the attribute 114 of FIG. 1. Illustratively, parser combinators can include those described in the first embodiment of FIG. 3 or the second embodiment of FIG. 8, both below. Parser combinators are small pieces of software code that parse particular types of text. They can be combined to build complex, powerful parsers.

Typically, parser combinators are used to parse structured text that follows a specific, rigid grammar. In the natural language parser 100 of the present disclosure, the parser combinators can be combined together with the parse false match step 204, the identify next candidate location step 206, and the skip step 208 to parse unstructured natural language text instead.

If the parse attribute step 210 can parse the attribute 114 from the candidate location or the next candidate location, the attribute 114 can be saved within the memory 118 and the natural language parser 100 will execute the identify next candidate location step 206. Furthermore, if the parse attribute step 210 fails to parse the attribute 114, the natural language parser 100 will also execute the identify next candidate location step 206.

In either case, the relevant characters of the candidate location or the next candidate location will be skipped together with any following irrelevant characters if another candidate location can be found. In this way, the natural language parser 100 can work through the character string 108 candidate location by candidate location skipping over any irrelevant characters therebetween and even skipping over relevant characters of candidate locations where the false match 116 and the attribute 114 are not recognized.

The natural language parser 100 can therefore skip the relevant characters of the candidate location and the irrelevant character following the candidate location based on the false match being parsed, the attribute 114 being parsed, and the attribute 114 not being parsed. This skipping ability enables the parsing of unstructured text that does not follow a particular structure, grammatical rules, or syntactic rigor. Furthermore, the skipping ability enables the parsing of the character string 108 with the limited computational resources 106 of FIG. 1 and without reliance on guessing and checking through enormous data models, which is common in machine learning or statistical methods.

As such, the identification of the candidate location, the skipping of the relevant characters and the irrelevant characters reflect an improvement in the functioning of a computer, in that the computational resources 106 are able to parse non-standard character strings 108. The skipping solution disclosed herein is therefore necessarily rooted in computer technology in order to overcome the problem of parsing unstructured text specifically arising in the realm of natural language parsers.

The identify candidate location step 202, the parse false match step 204, the identify next candidate location step 206, the skip step 208, and the parse attribute step 210 therefore control the technical process and the internal functioning of the computational resources 106 themselves. These steps further inherently reflect and arise due to technical features of the computational resources 106, which traditionally require carefully and correctly structured character strings.

Once the identify next candidate location step 206 is unable to identify a next candidate location, the natural language parser 100 can execute a modify attribute step 212. The modify attribute step 212 can change the attribute 114 stored in the memory 118.

As one illustrative example, the modify attribute step 212 is shown and described in FIG. 3 as demoting the attribute 114 type from an amount to a strength based on the attribute 114 being parsed and having no unit associated with the attribute 114.

Referring now to FIG. 3, therein is shown the parse attribute step 210 of FIG. 2 and the modify attribute step 212 of FIG. 2 in a first embodiment. The first embodiment is described in terms of a drug instruction parser; however, it is to be understood that the drug instruction parser is just one application of using parser combinators to parse natural language text and is presented here to give a concrete example of the technique, without limiting the disclosure thereto.

Furthermore, the parse attribute step 210 will be described below with regard to the candidate location. The parse attribute step 210 can run multiple parsers on the candidate location without skipping to the next candidate location by way of the identify next candidate location step 206 or the skip step 208, both of FIG. 2. The identify next candidate location step 206 and the skip step 208 will be executed, as described with regard to FIG. 2, when the parse attribute step 210 identifies and parses an attribute or when the parse attribute step 210 fails to parse any attribute.

The natural language parser 100 of FIG. 1 can begin the parse attribute step 210 with a duration attribute parser combinator 302. Illustratively, the duration attribute parser combinator 302 can parse the candidate location for duration patterns such as “x3 weeks” or “for 1-2 months” in order to parse a duration attribute 304. The duration attribute parser combinator 302 parses the duration attribute 304 by first skipping the relevant characters “x” or “for” along with any trailing white spaces.

Second, the duration attribute parser combinator 302 can parse a range of cardinal numbers and any trailing white spaces. Third, the duration attribute parser combinator 302 can parse a basic time unit with the candidate location. The duration attribute 304, once parsed, can be stored in the memory 118.

The natural language parser 100 can next execute a form attribute parser combinator 306. Illustratively, the form attribute parser combinator 306 can identify and parse drug forms, which are words such as “tablet”, “pill”, etc., or a synonym thereof, in order to identify and parse a form attribute 308.

The form attribute parser combinator 306 can parse the candidate location with a hard-coded list of known forms and their synonyms. For example, “tab” is a synonym for “tablet”. The form attribute 308, once parsed, can be stored in the memory 118.

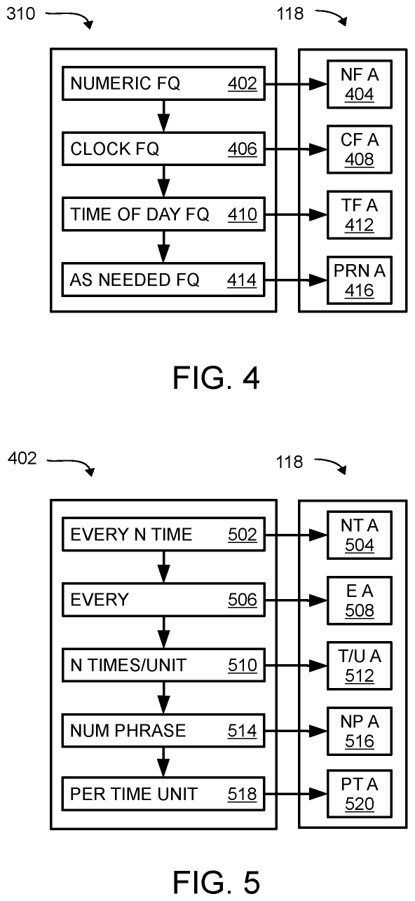

The natural language parser 100 can next execute a frequency attribute parser combinator 310. Illustratively, the frequency attribute parser combinator 310 can parse a frequency attribute 312 by recognizing several different patterns described in greater detail below in FIGS. 4 and 5. Because the frequency attribute parser combinator 310 can recognize many patterns, the frequency attribute 312 can take many different forms as well. The frequency attributes 312 parsed utilizing the frequency attribute parser combinators 310 depicted and described with regard to FIG. 4.

In one implementation, the frequency attribute parser combinator 310 can parse a numeric pattern or a clock time pattern such as 12:30 pm, for example. In another implementation, the frequency attribute parser combinator 310 will recognize and parse time of day patterns such as morning, afternoon, evening, bedtime, etc.

In yet another implementation, the frequency attribute parser combinator 310 can recognize and parse as needed patterns including “pm”, from the Latin “pro re nata”, for example. The frequency attribute 312, once parsed, can then be stored in the memory 118.

The natural language parser 100 can next execute a route attribute parser combinator 314. Illustratively, the route attribute parser combinator 314 can parse a drug route attribute 316, which can be recognized in the candidate location as a word such as “oral”, “transdermal”, etc., or a synonym.

For example, “po” is a synonym for “oral”. The route attribute parser combinator 314 can parse the drug route attribute 316 from a hard-coded list of known routes and their synonyms. Once the drug route attribute 316 has been parsed, the drug route attribute 316 can be stored in the memory 118.

The natural language parser 100 can next execute a strength attribute parser combinator 318. Illustratively, the strength attribute parser combinator 318 can parse a strength attribute 320 by recognizing several different patterns described in greater detail in FIG. 6, below.

The parse attribute step 210 can recognize two patterns for the strength attribute 320. These patterns include an explicit strengths or concentrations such as “135 mg/ml”, and ambiguous strengths. The strength attribute parser combinator 318 will only recognize the explicit strength concentrations.

The ambiguous strengths are initially recognized and parsed in an amount attribute parser combinator 322. The ambiguous strength is initially parsed as an amount or an amount attribute 324. As will be described in greater detail below, the modify attribute step 212 will demote the ambiguous strength identified as the amount attribute 324, to the strength attribute 320 when the amount attribute 324 has no unit associated therewith.

The strength attribute 320 can also be parsed by the strength attribute parser combinator 318 recognizing the explicit concentration strength. The strength attribute parser combinator 318 can parse the strength attribute 320 by recognizing a simple count/unit pattern, such as “135-150 mg/ml” or “30%”.

The strength attribute parser combinator 318 can also parse the strength attribute 320 by recognizing a ratio count/unit pattern, such as “3 mg/2 ml”. Furthermore, the strength attribute parser combinator 318 can parse the strength attribute 320 by recognizing a prefix count pattern, such as “1:100”. The strength attribute 320, once parsed, can be stored in the memory 118.

The natural language parser 100 can next execute the amount attribute parser combinator 322. Illustratively, the amount attribute parser combinator 322 can parse the amount attribute 324 by parsing a quantity, or range of quantities, skipping any trailing white space, and then parsing a basic quantity unit. The amount attribute 324, once parsed, can be stored in the memory 118.

When the amount attribute parser combinator 322 is able to parse the quantity, or range of quantities but is unable to parse the basic quantity unit, as previously described, the natural language parser 100 can execute the modify attribute step 212. The modify attribute step 212 can demote the amount attribute 324 recognized by the amount attribute parser combinator 322 to the strength attribute 320.

More particularly, the identification of one amount attribute 324 without a unit can trigger the modify attribute step 212 to demote every other amount attribute 324 detected within the character string 108 of FIG. 1, whether at the candidate location or the next candidate location. The modify attribute step 212 will demote the amount attributes 324 to the strength attributes 320.

Illustratively for example, in the character string 108: “3 pills (20 mg each) daily”, the “3” and “20 mg” are both originally parsed by the amount attribute parser combinator 322 as the amount attributes 324. However, since “3” has no unit, the “20 mg” originally parsed as the amount attribute 324 is demoted to the strength attribute 320 along with “3”. The amount attribute 324 and the demoted strength attribute 320, once parsed or demoted, can be stored in the memory 118.

Referring now to FIG. 4, therein is shown the frequency attribute parser combinator 310 of FIG. 3. The frequency attribute parser combinator 310 can employ multiple parser combinators.

The frequency attribute parser combinator 310 can parse the candidate location with a numeric frequency parser combinator 402. The numeric frequency parser combinator 402 can parse a numeric frequency attribute 404 by recognizing patterns described in greater detail in FIG. 5, below.

Generally, the numeric frequency parser combinator 402 can recognize the numeric frequency attribute 404 having the patterns: “every N time units”, or “N times per time unit”. The numeric frequency attribute 404, once parsed, can be stored in the memory 118.

The frequency attribute parser combinator 310 can further parse the candidate location with a clock-time frequency parser combinator 406 to parse a clock-time frequency attribute 408. The clock-time frequency parser combinator 406 can parse a clock time of “12:30 pm”, for example.

First, the clock-time frequency parser combinator 406 can parse a number of hours such as “12”. The clock-time frequency parser combinator 406 would then skip “:” and parse the number of minutes, “30”. If no colon is present, the clock-time frequency parser combinator 406 will assume 0 minutes after the hour.

The clock-time frequency parser combinator 406 can then skip the white space, if any. The clock-time frequency parser combinator 406 would further skip any known meridiem indicators which would be recognized from a hard-coded list, such as “am”, “pm”, etc. The clock-time frequency attribute 408, once parsed, can be stored in the memory 118.

The frequency attribute parser combinator 310 can further parse the candidate location with a time-of-day frequency parser combinator 410 to parse a time-of-day frequency attribute 412. The time-of-day frequency parser combinator 410 can parse a time of day from a known list of hard-coded values and synonyms. The time-of-day frequency attribute 412 can be parsed as morning from the hard-coded values of “morning”, “a.m.”, and other synonyms, and can be parsed as afternoon from the hard-coded values of “afternoon”, “p.m.”, and other synonyms.

The time-of-day frequency attribute 412 can be further parsed as evening from the hard-coded values of “evening”, “night”, and other synonyms, and can be parsed as bedtime from the hard-coded values of “bedtime”, “before bed”, “hs”, and other synonyms. The time-of-day frequency attribute 412 may optionally be preceded by an “every” term.

In practice this can include “every” but can also include the medical abbreviations such as: “qam” which is an abbreviation for “quaque ante meridiem” which can signify every morning, “qpm” which is an abbreviation for “quaque post meridiem” which can signify every afternoon, “qhs” which is an abbreviation for “quaque hora somni” which can signify every day at bed time. Other medical abbreviations can be used. The time-of-day frequency attribute 412, once parsed, can be stored in the memory 118.

The frequency attribute parser combinator 310 can further parse the candidate location with an as-needed frequency parser combinator 414. The as-needed frequency parser combinator 414 can parse an as needed attribute 416.

The as-needed frequency parser combinator 414 can parse the as needed attribute 416 from a known list of hard-coded values, including: “as needed”, and “pm”, which is an abbreviation for “pro re nata”. The as needed attribute 416, once parsed, can be stored in the memory 118.

Referring now to FIG. 5, therein is shown the numeric frequency parser combinator 402 of FIG. 4. The numeric frequency parser combinator 402 is shown having multiple parser combinators that will each parse the numeric frequency attribute 404 of FIG. 4.

The parser combinators described with regard to FIG. 5 should all be considered variations of the numeric frequency parser combinator 402 and the multiple different attributes parsed by these parser combinators should all be considered variations of the numeric frequency attribute 404.

The numeric frequency parser combinator 402 can parse the candidate location with an every N time unit parser combinator 502. The every N time unit parser combinator 502 can parse an every N time unit attribute 504 by recognizing a singular pattern, a plural pattern, or a known abbreviation.

Illustratively for example, the singular pattern “every day” can be parsed by first skipping the term “every” along with any trailing white spaces, and next parsing the singular basic time unit “day”. The plural pattern “every N hours”, for example, can be parsed by first skipping the term “every” along with the trailing white space. Next the range of whole numbers, “N”, can be parsed and any trailing white space skipped. Finally, the basic time unit “hours” can be parsed.

The every N time unit attribute 504 can also be parsed from a list of known abbreviations from a hard-coded list, which could include “qod”, for example, which means every other day. The every N time unit attribute 504, once pared, can be stored in the memory 118.

The numeric frequency parser combinator 402 can further parse the candidate location with an “every” term parser combinator 506. The “every” term parser combinator 506 can parse an “every” term attribute 508.

That is, the “every” term parser combinator 506 can parse a term that means “every” from a hard-coded lists of known values, including: “Every”, and “q”. The “every” term attribute 508, once parsed can be stored in the memory 118.

The numeric frequency parser combinator 402 can further parse the candidate location with an N times per time unit parser combinator 510. The N times per time unit parser combinator 510 can parse an N times per time unit attribute 512 by recognizing a full syntax pattern, an adverbial syntax pattern, or a known abbreviation. Illustratively, the N times per time unit parser combinator 510 can parse a full syntax pattern such as “1-2 times per day”.

First the N times per time unit parser combinator 510 will parse the numeric phrase such as “1-2” and skip any trailing white space from the full syntax pattern. Next the N times per time unit parser combinator 510 will parse the per-time-unit phrase “per day” or “daily”.

As a further illustration, the N times per time unit parser combinator 510 can parse the adverbial syntax pattern such as “daily”. As yet a further illustration, the N times per time unit parser combinator 510 can parse a known abbreviation from a hard-coded list such as “bid”, which indicates twice a day, and “tid”, which indicates three times a day. The N times per time unit attribute 512, once parsed can be stored in the memory 118.

The numeric frequency parser combinator 402 can further parse the candidate location with a numeric phrase parser combinator 514. The numeric phrase parser combinator 514 can parse a numeric phrase attribute 516 by recognizing a pattern of explicit number of times or a pattern of a numeric term. Illustratively, the numeric phrase parser combinator 514 can recognize an explicit number of times such as “1-2 times”.

The numeric phrase parser combinator 514 can first parse the range of cardinal numbers and skip any trailing white space. Then the numeric phrase parser combinator 514 will skip “time”, “times”, or “x”.

The numeric phrase parser combinator 514 can also parse a known numeric term from a hard-coded list such as “once”, “twice”, or “thrice”. The numeric phrase attribute 516, once parsed can be stored in the memory 118.

The numeric frequency parser combinator 402 can further parse the candidate location with a per-time-unit phrase parser combinator 518. The per-time-unit phrase parser combinator 518 can parse a per-time-unit phrase attribute 520 by recognizing a pattern of explicit introduction or an adverbial pattern. Illustratively, the explicit introduction could state “per day”, for example.

The per-time-unit phrase parser combinator 518 would first skip the introductory term “per”, “/”, “a”, or “an”. Next the per-time-unit phrase parser combinator 518 would parse a singular basic time unit, such as “day”.

When an adverbial pattern is included, the per-time-unit phrase parser combinator 518 will parse the adverbial basic time unit, for example “daily”. The per-time-unit phrase attribute 520, once parsed can be stored in memory 118.

Referring now to FIG. 6, therein is shown the strength attribute parser combinator 318 of FIG. 3. The strength attribute parser combinator 318 is shown having multiple parser combinators that will each parse the strength attribute 320 of FIG. 3.

The parser combinators described with regard to FIG. 6 should all be considered variations of the strength attribute parser combinator 318 and the multiple different attributes parsed by these parser combinators should all be considered variations of the strength attribute 320.

The strength attribute parser combinator 318 can parse the candidate location with a count per unit parser combinator 602. The count per unit parser combinator 602 can parse a count per unit attribute 604 by first parsing a range of quantities, and skipping any trailing white space. For example, the range of quantities could be “135-150”.

Next the count per unit parser combinator 602 can parse a concentration unit, such as “mg/ml”. The count per unit attribute 604, once parsed, can be stored in the memory 118.

The strength attribute parser combinator 318 can further parse the candidate location with a concentration unit parser combinator 606. The concentration unit parser combinator 606 can parse a concentration unit attribute 608 as a ratio, such as “mg/ml”. The concentration unit parser combinator 606 can further parse the concentration unit attribute 608 as a percent indicated by the “%” symbol. The concentration unit attribute 608, once parsed, can be stored in the memory 118.

The strength attribute parser combinator 318 can further parse the candidate location with a ratio count per unit parser combinator 610. The ratio count per unit parser combinator 610 can parse a ratio count per unit attribute 612 as a ratio of two measurements. First, the ratio count per unit parser combinator 610 can parse a numerator within the candidate location as a rational count followed by a basic quantity unit and skip any white space in between.

Next, the ratio count per unit parser combinator 610 can parse the division symbol “/” and skip any white space before or after. Lastly, the ratio count per unit parser combinator 610 can parse a denominator of the candidate location as a rational count followed by a basic quantity unit and skip any white space in between. The ratio count per unit attribute 612, once parsed, can be stored in the memory 118.

The strength attribute parser combinator 318 can still further parse the candidate location with a prefix count parser combinator 614. The prefix count parser combinator 614 can parse a prefix count attribute 616 by parsing a concentration strength of the form “1:N”, where N can also be a range, such as “1:100-200”, for example. The prefix count attribute 616, once parsed, can be stored in the memory 118.

Referring now to FIG. 7, therein is shown the parse false match step 204 of FIG. 2. The parse false match step 204 is shown having multiple parser combinators that will each parse the false match 116 of FIG. 1.

The parser combinators described with regard to FIG. 7 should all be considered false match parser combinators, which can be operated during the parse false match step 204. The multiple different attributes parsed by these parser combinators should all be considered variations of the false match 116. It is also contemplated that other parser combinators could be included as needed to identify other potential false matches.

The parse false match step 204 can parse the candidate location with a date parser combinator 702. The date parser combinator 702 can parse a date false match attribute 704 and skip over the date false match attribute 704. The date parser combinator 702 can parse a month as a whole number, skip a divider symbol “/”, parse a day as a whole number, skip another divider symbol “/”, and finally parse a year as a whole number.

Once the date false match attribute 704 is identified and parsed, the natural language parser 100 of FIG. 1 can execute the identify next candidate location step 206 and the skip step 208, both of FIG. 2. The date false match attribute 704 can then be skipped from the character string 108 of FIG. 1.

The parse false match step 204 can parse the candidate location with a phone number parser combinator 706. The phone number parser combinator 706 can parse a phone number attribute 708 and skip over the phone number attribute 708. The phone number parser combinator 706 can parse an area code as a whole number, skip a hyphen, parse an exchange number as a whole number, skip another hyphen, and parse a subscriber number as a whole number.

Once the phone number attribute 708 is identified and parsed, the natural language parser 100 can execute the identify next candidate location step 206 and the skip step 208. The phone number attribute 708 can then be skipped from the character string 108.

Referring now to FIG. 8, therein is shown the parse attribute step 210 of FIG. 2 in a second embodiment. The second embodiment is described in terms of a general purpose parser combinator; however, it is to be understood that the general purpose parser is just one application of using parser combinators to parse natural language text and is presented here to give an illustrative example of the technique, without limiting the disclosure thereto.

Furthermore, the parse attribute step 210 will be described below with regard to the candidate location. The parse attribute step 210 can run multiple parsers on the candidate location without skipping to the next candidate location by way of the identify next candidate location step 206 or the skip step 208, both of FIG. 2. The identify next candidate location step 206 and the skip step 208 will be executed, as described with regard to FIG. 2, when the parse attribute step 210 identifies and parses an attribute or when the parse attribute step 210 fails to parse any attribute.

The natural language parser 100 of FIG. 1 can begin the parse attribute step 210 with a term parser combinator 802, which can parse a term attribute 804 as hard-coded terms including drug routes, forms of the drug, and others.

The hard-coded terms can also include their synonyms. The term parser combinator 802 can therefore parse the term attribute 804 by matching a complete string of characters within the candidate location.

The term parser combinator 802 will not recognize terms that end between two letters, or between two digits, such as “tab”, which matches “tab”, but not “table”. The term attribute 804, once parsed can be stored in the memory 118.

The parse attribute step 210 can further parse the candidate location with a numeric parser combinator 806. The numeric parser combinator 806 can parse a numeric attribute 808.

Many different types of numbers can be recognized as the numeric attribute 808. The numeric parser combinator 806 can recognize whole numbers, such as “12345” or “12,345”. The whole numbers can include cardinal numbers, such as “2” or “two”. The whole numbers can also include ordinal numbers, such as “second” or “2nd”.

The numeric parser combinator 806 can further recognize rational numbers. The rational numbers recognized can include simple fractions like “¾”, mixed fractions like “1½”, and decimals such as “.25” or “0.25”. Once the numeric attribute 808 is recognized as either the whole number or the rational number, the numeric attribute 808 can be stored in the memory 118.

The parse attribute step 210 can further parse the candidate location with a range parser combinator 810. The range parser combinator 810 can parse a range attribute 812 having a numeric start and end value, such as “3-4” or “3 to 4”.

A single standalone numeric value can also be interpreted as a range. For example, “3” is the range from 3 to 3. The numeric value in a range can be a whole number, a rational number, or a quantity. The quantity could be represented as “2 mg”, for example. The range attribute 812, once parsed, can be stored in the memory 118.

The parse attribute step 210 can further parse the candidate location with a quantity parser combinator 814. The quantity parser combinator 814 can parse a quantity attribute 816 which can be a numeric value followed by a unit, such as “2 mg”.

The quantity parser combinator 814 can parse and recognize many quantities as the quantity attribute 816. Illustratively, the quantity parser combinator 814 can parse hard-coded basic units, such as “ml” or “g”. The quantity parser combinator 814 can further parse a ratio unit, such as “mg/ml”. The quantity parser combinator 814 can still further parse a percent, by recognizing the “%” symbol. The quantity parser combinator 814 can still further parse a reciprocal, such as “1:”. The quantity attribute 816, once parsed, can be stored in the memory 118.

The parse attribute step 210 can further parse the candidate location with a time parser combinator 818. The time parser combinator 818 can parse a time attribute 820 by recognizing several different basic time unit patterns.

The time parser combinator 818 can recognize and parse a basic singular time unit and their synonyms, such as “second”, “minute”, “hour”, and other similar singular time units. The time parser combinator 818 can further parse plural time units and their synonyms, such as “seconds”, “minutes”, “hours”, and other similar plural time units.

The time parser combinator 818 can yet further parse adverbial time units, such as “hourly”, “daily”, “weekly”, and other similar adverbial time units. The complete time attribute 820 parsed by the time parser combinator 818 can be comprised of a basic time unit like “hour”, or an inverse time unit like “per hour”.

Inverse time units are used, for example, in parsing the drug frequency attribute, such as “3 times a day”, which has a unit of 1/day. The time attribute 820, once parsed, can be stored in the memory 118.

It will be appreciated by those of ordinary skill in the art, that the ability of the natural language parser 100 to skip through the character string 108 provides a concrete improvement in natural language parser technologies, because the disclosed natural language parser 100 can return attributes from the character string 108, even when the character string 108 includes portions which the parser combinators cannot parse or that produce false matches.

Further, the natural language parser 100 can run on limited computational resources 106 unlike statistical machine learning parsers which require large amounts of computational resources 106 and massive data models.

Yet further, the natural language parser 100 combines parser combinators that skip over irrelevant content with other parser combinators that identify and parse relevant information. This combination allows the parser to scan the character string 108 without getting derailed by syntax that it does not understand.

It will be appreciated that the steps of identifying a candidate location, attempting to parse an attribute, and skipping the relevant characters of the candidate location and the irrelevant character following the candidate location to the next candidate location based on the attribute not being parsed with the processor are steps necessarily rooted in technology as these steps solve a long standing problem arising in previous natural language parsers. Furthermore, parser combinators are not known to be applied within the human mind when reading notes.

Thus, it has been discovered that the natural language parser furnishes important and heretofore unknown and unavailable solutions, capabilities, and functional aspects. The resulting configurations are straightforward, cost-effective, uncomplicated, highly versatile, accurate, and effective, and can be implemented by adapting known components for ready, efficient, and economical application, and utilization.

While the natural language parser has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A method of operating a skipping natural language parser comprising:
identifying a candidate location within a string of characters with a processor, the candidate location being an unbroken string of relevant characters followed by an irrelevant character;
attempting to parse an attribute from the candidate location with the processor;
storing the attribute in a memory based on the attribute being parsed;
skipping to a next candidate location based on the attribute being parsed with the processor; and
skipping, the relevant characters of the candidate location and the irrelevant character following the candidate location, to the next candidate location based on the attribute not being parsed with the processor.

2. The method of claim 1 further comprising:
attempting to parse a false match from the candidate location with the processor;
skipping, the relevant characters of the candidate location and the irrelevant character following the candidate location, to the next candidate location based on the false match being parsed with the processor; and
wherein:
attempting to parse the attribute from the candidate location is based on the false match not being parsed, and
skipping to the next candidate location based on the attribute being parsed is also based on the false match not being parsed.

3. The method of claim 2 wherein attempting to parse the false match includes identifying a format of the relevant characters with the processor.

4. The method of claim 1 wherein attempting to parse the attribute includes parsing the candidate location with a parser combinator using the processor.

5. The method of claim 1 further comprising demoting the attribute, with the processor, from an amount to a strength based on the attribute being parsed and having no unit associated with the attribute.

6. The method of claim 1 wherein identifying the candidate location includes identifying the candidate location with the relevant characters being predefined in the memory.

7. The method of claim 1 wherein identifying the candidate location includes identifying the candidate location with the irrelevant character being predefined in the memory.

8. A non-transitory computer readable medium in useful association with a processor having instructions configured to:
identify a candidate location within a string of characters with the processor, the candidate location being an unbroken string of relevant characters followed by an irrelevant character;
attempt to parse an attribute from the candidate location with the processor;
store the attribute in a memory based on the attribute being parsed;
skip to a next candidate location based on the attribute being parsed with the processor; and
skip, the relevant characters of the candidate location and the irrelevant character following the candidate location, to the next candidate location based on the attribute not being parsed with the processor.

9. The computer readable medium of claim 8 further comprising instructions configured to:
attempt to parse a false match from the candidate location with the processor;
skip, the relevant characters of the candidate location and the irrelevant character following the candidate location, to the next candidate location based on the false match being parsed with the processor; and
wherein the instructions configured to:
attempt to parse the attribute from the candidate location is based on the false match not being parsed, and
skip to the next candidate location based on the attribute being parsed is also based on the false match not being parsed.

10. The computer readable medium of claim 9 wherein the instructions configured to attempt to parse the false match includes instructions configured to identify a format of the relevant characters with the processor.

11. The computer readable medium of claim 8 wherein the instructions configured to attempt to parse the attribute includes instructions configured to parse the candidate location with a parser combinator using the processor.

12. The computer readable medium of claim 8 further comprising instructions configured to demote the attribute, with the processor, from an amount to a strength based on the attribute being parsed and having no unit associated with the attribute.

13. The computer readable medium of claim 8 wherein the instructions configured to identify the candidate location include instructions configured to identify the relevant characters being predefined in the memory.

14. The computer readable medium of claim 8 wherein the instructions configured to identify the candidate location include instructions configured to identify the irrelevant character being predefined in the memory.

15. A skipping natural language parser comprising a processor configured to:
identify a candidate location within a string of characters, the candidate location being an unbroken string of relevant characters followed by an irrelevant character;
attempt to parse an attribute from the candidate location;
store the attribute in a memory based on the attribute being parsed;
skip to a next candidate location based on the attribute being parsed with the processor; and
skip, the relevant characters of the candidate location and the irrelevant character following the candidate location, to the next candidate location based on the attribute not being parsed with the processor.

16. The skipping natural language parser of claim 15 wherein the processor is further configured to:
attempt to parse a false match from the candidate location;
skip, the relevant characters of the candidate location and the irrelevant character following the candidate location, to the next candidate location based on the false match being parsed with the processor; and
wherein the processor configured to:
attempt to parse the attribute from the candidate location is based on the false match not being parsed, and
skip to the next candidate location based on the attribute being parsed is also based on the false match not being parsed.

17. The skipping natural language parser of claim 16 wherein the processor configured to attempt to parse the false match is configured to identify a format of the relevant characters.

18. The skipping natural language parser of claim 15 wherein the processor configured to attempt to parse the attribute is configured to parse the candidate location with a parser combinator.

19. The skipping natural language parser of claim 15 wherein the processor is further configured to demote the attribute from an amount to a strength based on the attribute being parsed and having no unit associated with the attribute.

20. The skipping natural language parser of claim 15 wherein the processor configured to identify the candidate location is configured to identify the relevant characters being predefined in the memory.
